(19) United States
(12) Patent Application Publication
(10) Pub. No.: US 2010/0037472 A1
(43) Pub. Date: Feb. 18, 2010

(54) Chainsaw guide bar and method of making

(75) Inventors: Delbert E. Lucas, Bowling Green, KY (US); Robert M. Shymkus, Bowling Green, KY (US); Jeremy L. Buttery, Tempe, AZ (US)

Correspondence Address: WEGMAN, HESSLER & VANDERBURG, 6055 ROCKSIDE WOODS BOULEVARD, SUITE 200, CLEVELAND, OH, 44131, US

(73) Assignee: MTD Products Inc, Valley City, OH (US)

(21) Appl. No.: 12/583,130

(22) Filed: Aug. 14, 2009

Related U.S. Application Data
(60) Provisional application No. 61/188,936, filed on Aug. 14, 2008.
(60) Provisional application No. 61/192,095, filed on Sep. 15, 2008.

(51) Int. Cl. B27B 17/02; B21D 22/00

(52) U.S. Cl. 30/383; 72/362

(57) ABSTRACT

A chainsaw has a saw chain connected so as to be driven by the motor and a guide bar for guiding and supporting the saw chain as it revolves around the periphery of the guide bar. The guide bar has a channel formed by alternatively offset tabs, wherein each tab is offset from its immediate two adjacent tabs such that there is an open segment in the channel opposite each tab. There is a first set of tabs on a first side of the guide bar and a second set of tabs on the opposite side of the guide bar, wherein the alternatively offset tabs keep the cutting chain centered in the channel formed between the first set of tabs and the second set of tabs.

### CROSS-REFERENCE TO RELATED APPLICATION

This application claims the priority benefit of U.S. Provisional Patent Application Ser. No. 61/188,936 filed Aug. 14, 2008 and U.S. Provisional Patent Application Ser. No. 61/192,095 filed Sep. 15, 2008.

### BACKGROUND OF THE INVENTION

1. Field of the Invention

The present disclosure generally relates to the field of chainsaws, and more particularly to an improved guide bar for supporting a cutting chain of the chainsaw.

2. Description of Related Art

A chain saw is basically made up of three components. The power head includes a motor that drives a sprocket. A guide bar is attached to and extends outwardly from the sprocket of the power head. A cutting chain is entrained on the guide bar to be driven by the sprocket and guided by the guide bar for cutting operation.

The guide bar is an oval-shaped metal plate defining along its edge an oval path for the cutting chain. The path around the bar edge is typically characterized by a center groove flanked by side rails. The saw chain is made up of side links and center links. Tang portions extend from the center links into the groove and ride in the groove to guide and support the saw chain revolving around the periphery of the guide bar.

The guide bars typically have been either solid, i.e., made from a single steel plate with a milled or ground groove formed therein, or laminated, i.e., made from three thinner plates joined by spot welding, with the groove being created by making the middle plate smaller than the side plates. The method of construction of the single plate bar contains the time-consuming and difficult step of machining the groove and the laminated bar includes the multiple steps of forming the three plates and assembling them in stacked relation, and welding the plates together. It is therefore desired to provide an improved guide bar having a simple and light weight construction, and a simple method of making such a bar.

### SUMMARY OF THE INVENTION

In one embodiment, the invention is directed to a chainsaw powered by a motor housed by a chainsaw body. The chainsaw includes a saw chain connected so as to be driven by the motor and a guide bar for guiding and supporting the saw chain as it revolves around the periphery of the guide bar. The guide bar has a channel formed by alternatively offset tabs, wherein each tab is offset from its immediate two adjacent tabs such that there is an open segment in the channel opposite each tab. There is a first set of tabs on a first side of the guide bar and a second set of tabs on the opposite side of the guide bar, wherein the alternatively offset tabs keep the cutting chain centered in the channel formed between the first set of tabs and the second set of tabs.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The structure, operation, and advantages of the presently disclosed embodiment of the invention will become apparent when consideration of the following description taken in conjunction with the accompanying drawings wherein:

FIG. 1 is an isometric view of a chainsaw implementing a chainsaw guide in accordance with an embodiment of the invention;

FIG. 2 is an isometric view of a chainsaw guide illustrated in n FIG. 1;

FIG. 3A is an enlarged partial isometric view of offset segments of the chainsaw guide illustrated in FIG. 2;

FIG. 3B is partial cross-sectional of offset segments of the chainsaw guide illustrated in FIG. 2;

FIG. 4A is an enlarged partial isometric view of offset segments of the chainsaw guide in an alternate embodiment;

FIG. 4B is partial cross-sectional of offset segments of the chainsaw guide illustrated in FIG. 4A;

FIG. 5A is an enlarged partial isometric view of offset segments of the chainsaw guide in an alternate embodiment; and

FIG. 5B is partial cross-sectional of offset segments of the chainsaw guide illustrated in FIG. 5A;

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

The singular forms “a,” “an” and “the” include plural referents unless the context clearly dictates otherwise. The endpoints of all ranges reciting the same characteristic are independently combinable and inclusive of the recited endpoint. All references are incorporated herein by reference.

The modifier “about” used in connection with a quantity is inclusive of the stated value and has the meaning dictated by the context (e.g., includes the tolerance ranges associated with measurement of the particular quantity).

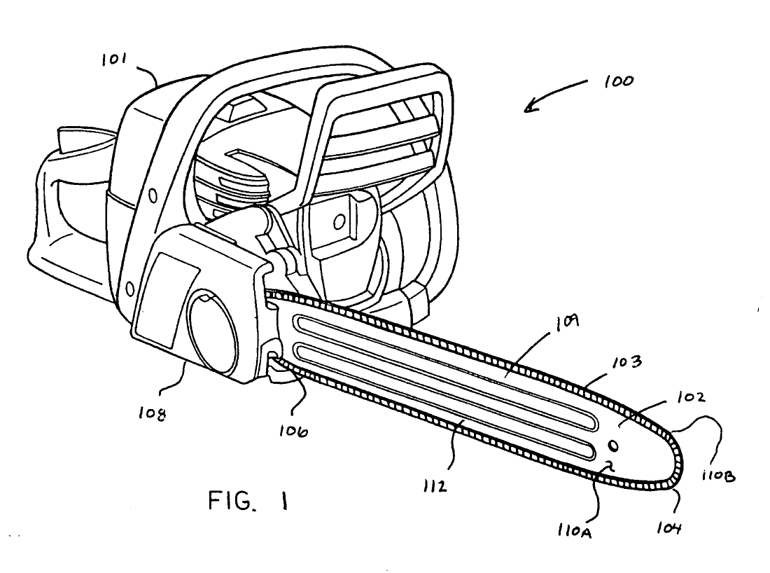

Referring generally to FIG. 1, a chainsaw 100 is illustrated in accordance with one exemplary embodiment of the present disclosure. The chainsaw 100 has a body 101 which incorporates a conventional motor and a guide bar 102 for supporting a saw chain 103. The saw chain 103 is supported by the guide bar 102 at a first end 104 of the guide bar 102, and is connected to and driven by a chain-drive output (not shown), such as an engine's drive sprocket, proximal to a second end 106 of the guide bar 102. The chain drive output is desirably protected by a cover 108 attached to the body 101 of the chainsaw 100. The guide bar 102 comprises a longitudinal frame 109 having two, substantially flat sides, one of the flat sides 110A generally facing away from the body 101 and the other one of the flat sides 110B facing generally towards the body 101. The frame 109 may have cutouts or indentations 112 to lighten or strengthen the guide bar 102. One skilled in the art will understand that the guide bar 102 may be mounted on the body 101 and the saw chain 103 driven around the guide bar 102 using any method and configuration known in the art and need not be described in further detail herein.

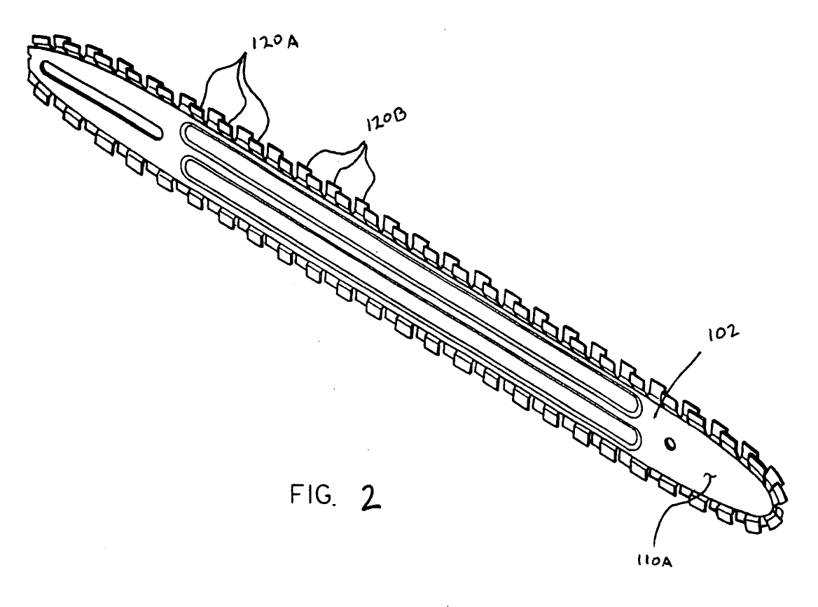

Turning now to FIG. 2, according to the invention the guide bar 102 includes alternatively offset tabs 120A, 120B for guiding the saw chain 103 around the guide bar 102. The tabs are divided into a first set, comprising tabs 120A, configured to be on side 110A of the guide bar 102, and a second set, comprising tabs 120B, configured to be on side 110B of the guide bar 102. The alternatively offset tabs 120 keep the cutting chain 103 centered in a channel extending around the periphery of the guide bar 102 formed between tabs 120A and tabs 120B.

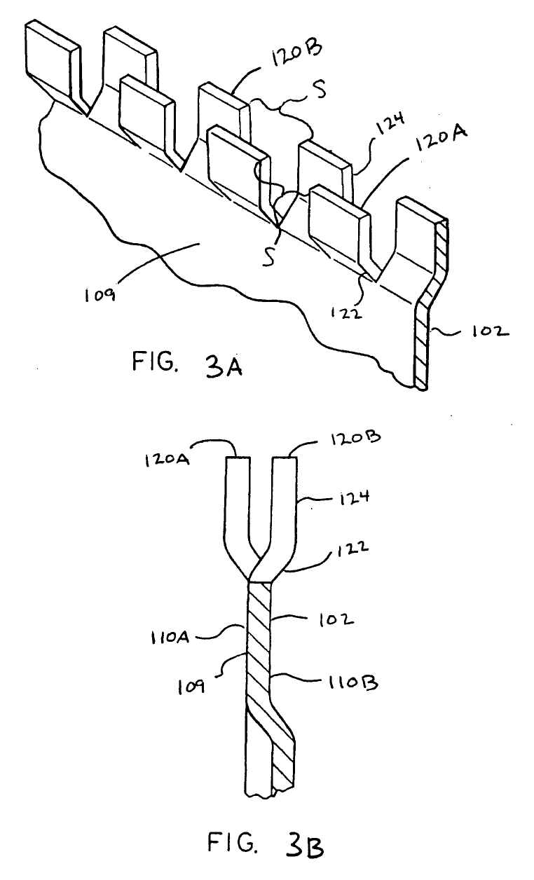

As best seen in FIGS. 3A and 3B, each tab 120A, 120B has an angled transition segment 122 extending outward from a plane encompassing the frame 109 and a tip 124 that is substantially parallel with the plane of the frame such that the tips form the boundary of the channel in which the saw chain 103 travels. Each tab 120A, 120B is offset from its immediate two adjacent tabs 120B, 120A such that there is an open segment S in the opposing side of the channel. Desirably, the alternatively offset tabs 120A, 120B are sized and spaced to provide a contact ratio with the links of the saw chain 103 greater than one, such that each link of the saw chain 103 guided by the guide bar 102 is in contact with at least two offset segments at any given point around the periphery of the guide bar 102. The open segments S may allow the guide bar 102 and saw chain 103 to use a dry lubrication system that would fit into the open segments S of the guide bar 102 and provide sufficient lubrication to the guide bar 102 and the saw chain 103 to eliminate the need for oil or any other fluid lubrication.

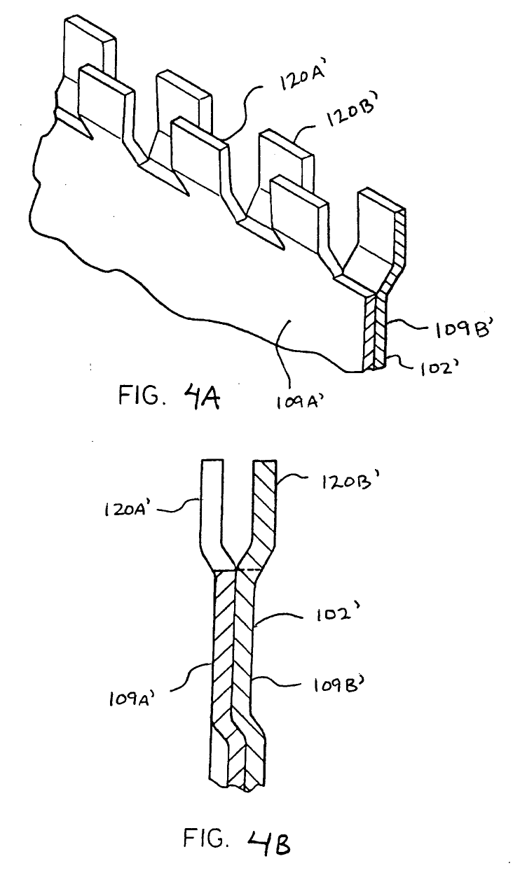

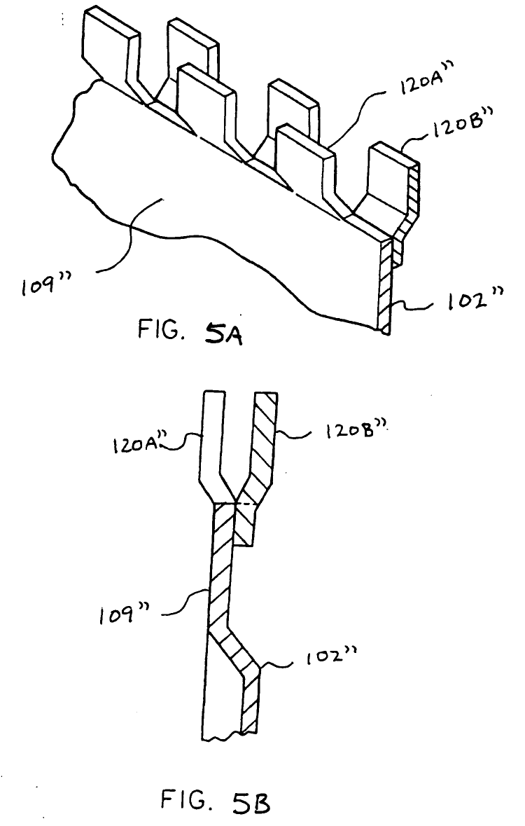

One embodiment of the invention is directed to a method for making the guide bar 102 out of a single plate such that the tabs are an integral part of the guide bar 102 and need not be welded or otherwise affixed to the longitudinal frame 109. First, a blank is made using conventional means. In a second stamping step, the offset tabs 120A, 120B are formed in the bar 102. Thus, the method forms the channel in the guide bar 102 by stamping the offset tabs 120A, 120B without a milling or grinding step. However, FIGS. 4A and 4B illustrate an alternate embodiment in which the guide bar 102′ is formed out of two plates such that a first frame 109A′ is formed with the tabs 120A′ and a second frame 109B′ is formed with the tabs 120B′. The two frames 109A′ and 109B′ are welded or otherwise attached together to form the guide bar 102′. FIGS. 5A and 5B illustrate yet another embodiment in which the guide bar 102″ is formed of a single frame 109″ with the tabs 120A″ formed as integral parts of the guide bar. Tabs 120B″ are welded or otherwise attached to the frame 109″.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention.

What is claimed is:

1. A chainsaw powered by a motor housed by a chainsaw body, the chainsaw comprising:
a saw chain connected so as to be driven by the motor;
a guide bar having a channel for supporting the cutting chain as it revolves around the periphery of the guide bar, the channel formed by a plurality of alternatively offset tabs, wherein each tab is offset from its immediate two adjacent tabs such that there is an open segment in the channel opposite each tab.

2. The chainsaw of claim 1 wherein the tabs comprise a first set of tabs on a first side of the guide bar and a second set of tabs on the opposite side of the guide bar, wherein the cutting chain is centered in said channel between the first set of tabs and the second set of tabs.

3. The chainsaw of claim 1 wherein each tab has an angled transition segment extending outward from a plane encompassing the frame and a tip substantially parallel with the said plane.

4. The chainsaw of claim 1 wherein tabs provide a contact ratio with the links of the saw chain greater than one, such that each link of the saw chain is in contact with at least two offset tabs around the periphery of the guide bar.

5. The chainsaw of claim 1 wherein the guide bar is constructed of a single plate such that the tabs are an integral part of the guide bar.

6. A guide bar for use with a chainsaw for supporting a saw chain around the periphery thereof, the guide bar comprising a plurality of alternatively offset tabs forming a channel configured to receive the saw chain, wherein each tab is offset from its immediate two adjacent tabs such that there is an open segment in the channel opposite each tab.

7. The guide bar of claim 6 wherein the tabs comprise a first set of tabs on a first side of the guide bar and a second set of tabs on the opposite side of the guide bar, wherein the cutting chain is centered in said channel between the first set of tabs and the second set of tabs.

8. The guide bar of claim 6 wherein each tab has an angled transition segment extending outward from a plane encompassing the frame and a tip substantially parallel with the said plane.

9. The guide bar of claim 6 wherein tabs provide a contact ratio with the links of the saw chain greater than one, such that each link of the saw chain is in contact with at least two offset tabs around the periphery of the guide bar.

10. The guide bar of claim 6 wherein the guide bar is constructed of a single plate such that the tabs are an integral part of the guide bar.

11. A method for forming a guide bar for use with a chainsaw said method comprising stamping a single metal plate creating a plurality of alternatively offset tabs that form a channel configured to receive a saw chain, wherein each tab is offset from its immediate two adjacent tabs such that there is an open segment in the channel opposite each tab.
